(19) United States
(12) Patent Application Publication
(10) Pub. No.: US 2009/0231871 A1
(43) Pub. Date: Sep. 17, 2009

(54) DIRECTION INDICATOR LAMP

(76) Inventor: Yung-Fa LIN, Banqiao City (TW)

Correspondence Address: RABIN & Berdo, PC, 1101 14TH STREET, NW, SUITE 500, WASHINGTON, DC, 20005, US

(21) Appl. No.: 12/048,484

(22) Filed: Mar. 14, 2008

(51) Int. Cl. B60Q 1/34

(52) U.S. Cl. 362/487

(57) ABSTRACT

A direction indicator lamp mainly includes lamp fittings in pairs and corresponding sensing and emitting modules. The light fitting has a light source, a receiver, and a battery set disposed therein. The sensing and emitting module senses a signal frequency when the direction lamp is operated, or senses lights when the direction lamp emits lights, so as to generate a control signal. Then, the light fitting is actuated to emit lights by means of a wireless transmission technique, so as to omit fussy procedures and complicated wiring process during installation.

### BACKGROUND OF THE INVENTION

1. Field of the Invention

The present invention relates to an automotive direction indicator lamp operated in a wireless sensing manner.

2. Related Art

The automotive external indicator lamp commonly used in daily life includes a direction indicator assisting the steering motion, and a third brake lamp assisting the braking motion, and such indicator lamps are usually electrically connected to a controller, a power source, and a lamp through electrical connecting wires. The controller is usually located within a vehicle, and the lamp is located at a proper position on the surface of the vehicle, for example, head of the vehicle, two sides of the vehicle body, tail of the vehicle, or rearview mirror.

Taking the direction lamp for an example, referring to FIG. 1, it is a schematic view of an installation of a conventional direction lamp. The direction lamps 10 include front and back direction lamps 10, rearview mirror direction lamp 10, and direction lamps 10 on two sides of the vehicle body and so on. When the direction lamps 10 are installed, the installation personnel must electrically connect the direction lamps 10 located on each part of the vehicle 20 to a lamp number controller 201 and a power source 202 of the vehicle 20 through a plurality of electrical connecting wires 101, and as a result, the circuits spread all over an inner structure of the vehicle 20. It can be known that, the wiring operation is rather complicated, and what's worse, the electrical connecting wires 101 must pass back and forth among plate parts and plastic components within the vehicle body. The installation and maintenance are quite inconvenient. Furthermore, due to the vibrations produced during the running of the vehicle 20, frictions are generated between the electrical connecting wires 101 and the plate parts and the plastic components, which may cause the abrasion and stripping of the electrical connecting wires 101, and as a result, the direction lamp 10 cannot work normally, thereby affecting the travel safety of the vehicle.

### SUMMARY OF THE INVENTION

In view of the disadvantages of the conventional direction lamp in terms of installation and usage, the inventors of the present invention design a novel externally-connected direction indicator lamp based upon the hard research and years of experience in this field.

The present invention is mainly directed to a direction indicator lamp, which is capable of omitting the fussy procedures and complicated wiring process during the installation through using a sensing signal and wireless transmission technique to replace the conventional way of installation through using electrical connecting wires for wiring.

In order to achieve the above objective, the direction indicator lamp provided by the present invention mainly includes lamp fittings in pairs and corresponding sensing and emitting modules. The lamp fitting has a light source, a receiver, and a battery set disposed within a case thereof, and the light source, the receiver, and the battery set are integrated on a circuit board. During installation, the case is adhered on an external part of the vehicle (for example, a surface of the vehicle body, left and right rearview mirrors, or windscreen, etc). The sensing and emitting module is mounted on one side of the lamp number controller, or located within an original direction lamp. The sensing and emitting module is formed by a sensor and an emitter, which is used to sense a signal frequency when the lamp number controller is operated, or sense lights when the direction lamp emits lights, so as to generate a control signal. Then, the control signal is sent to the receiver of the light fitting through the emitter by means of wireless transmission, so as to actuate the light source to emit lights. Therefore, the present invention can be installed without using any electrical connecting wire, so as to avoid using a great number of electrical connecting wires for wiring as the conventional lamp is installed, and thus avoiding the problems of damage and short circuit of the electrical connecting wires resulted from the friction.

### BRIEF DESCRIPTION OF THE DRAWINGS

FIG. 1 is a schematic view of an installation of a conventional direction lamp;

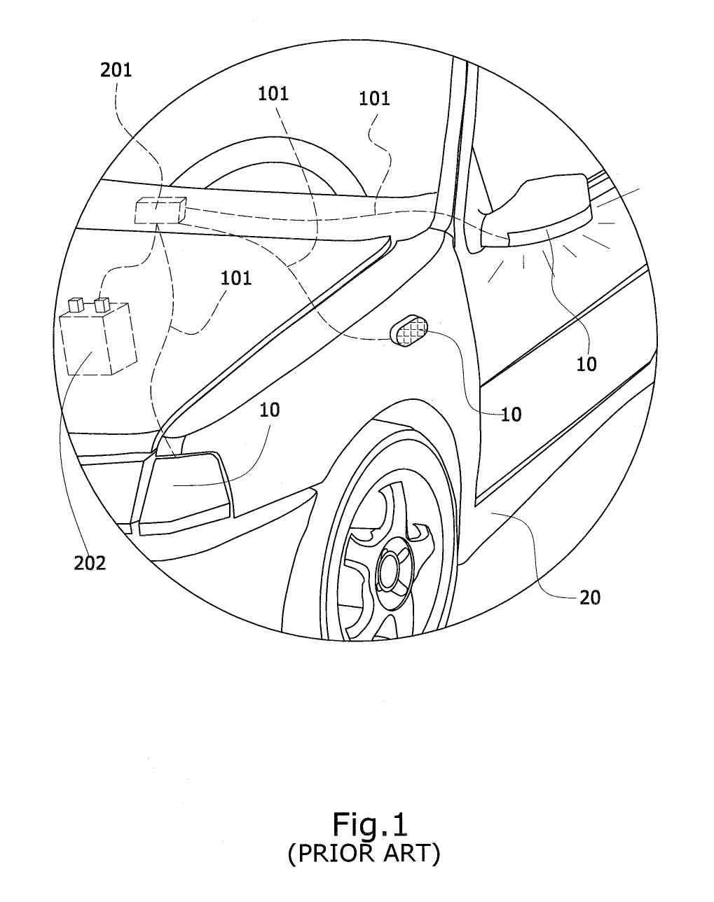

FIG. 2 is a schematic view of an installation of a preferred embodiment of the present invention;

FIG. 3 is a three-dimensional exploded view of a preferred embodiment of the present invention; and

FIG. 4 is a hardware block diagram of a preferred embodiment of the present invention.

### DETAILED DESCRIPTION OF THE INVENTION

In order to make the content of the present invention be understood more clearly, embodiments accompanied with figures are described in detail below.

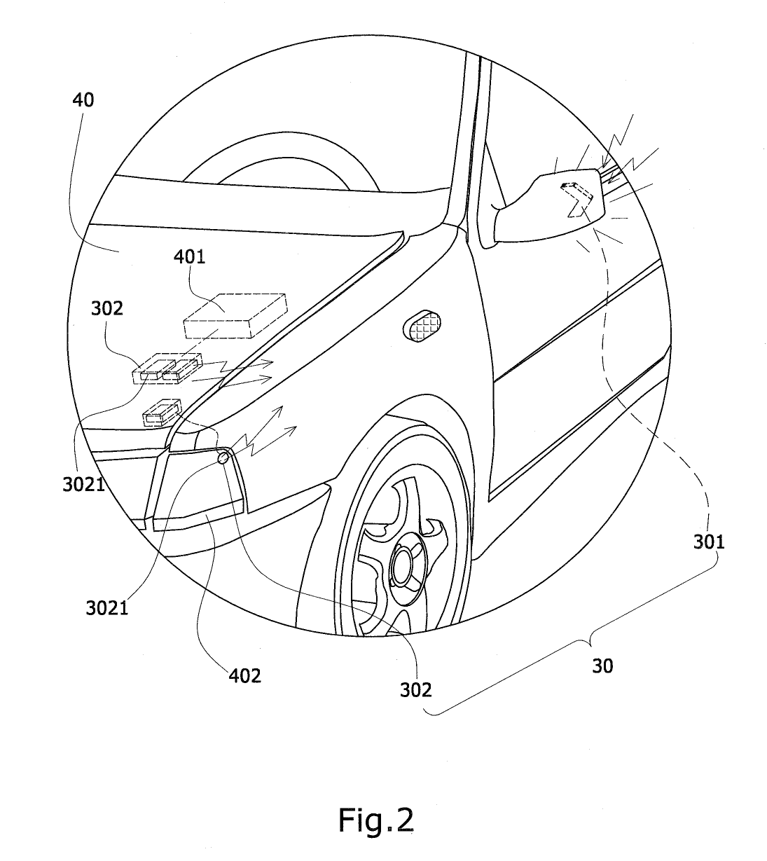

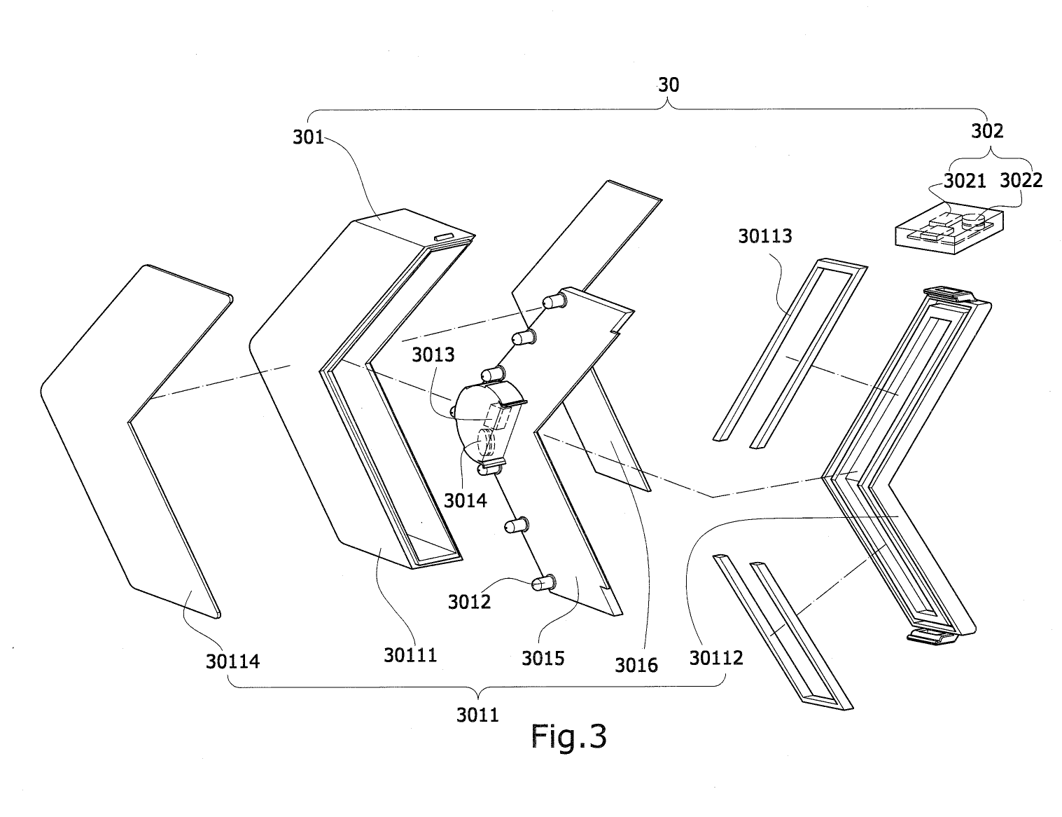

Referring to FIGS. 2 and 3, they are respectively a schematic view and a three-dimensional exploded view of an installation of a preferred embodiment of the present invention. A direction indicator lamp 30 of the present invention mainly includes lamp fittings 301 in pairs and corresponding sensing and emitting modules 302. The lamp fittings 301 are adhered on an external part of a vehicle 40 (for example, a surface of the vehicle body, rearview mirror, or windscreen etc), and the sensing and emitting module 302 is disposed on one side of the lamp number controller 401, or located within an original direction lamp 402 of the vehicle 40. The direction indicator lamp mainly includes a light fitting 301 and a sensing and emitting module 302. The light fitting 301 has a light source 3012 (a plurality of LEDs or conventional bulbs), a receiver 3013, and a battery set 3014 disposed within a case thereof. The light source 3012, the receiver 3013, and the battery set 3014 are disposed on a circuit board 3015, and the light source 3012 and the receiver 3013 are electrically connected to the battery set 3014 respectively. Once the receiver 3013 receives the signal, the light source 3012 is actuated to emit lights. Furthermore, the case 3011 is L-shaped (as shown in the figure, during installation, the case 3011 is rotated for 90 degrees when being disposed, so as to achieve an indicating effect similar to the configuration with left and right arrows), and is formed by mutually assembling a transparent first case 30111 with a second case 30112. A waterproof ring 30113 is disposed at a position where the first case 30111 is assembled with the second case 30112. A semi-permeable mirror 30114 is disposed on one surface of the first case 30111. When the light source 3012 does not emit lights, a light-tight mirror may be formed on the surface of the semi-permeable mirror 30114 for reflecting lights irradiated from the back of the vehicle, which thus achieves another indicating effect. When the light source 3012 of the present invention emits lights, the lights penetrate through the semi-permeable mirror 30114 to form an indicating effect for steering. In addition, an adhesion portion 3016 (such as adhesion tapes, sucking disk, or magnet commonly used in the daily life) is disposed on the other surface of the case 3011, so as to conveniently adhere the case 3011 on each position of the vehicle 40 in a nondestructive manner. For example, the adhesion tape or sucking disk is used on a smooth surface, and as for a metal part of the vehicle, the magnet may be used for adhesion. In this manner, it is convenient to disassemble the case 3011 for replacing the battery set 3014 or making maintenance. In addition, the sensing and emitting module 302 includes a sensor 3021 and an emitter 3022. The sensor 3021 and the emitter 3022 are communicated with each other. The sensing and emitting module 302 is disposed on one side of the lamp number controller 401 of the vehicle 40, or located within the original direction lamp 402 of the vehicle 40 (when being disposed on one side of the lamp number controller 401, the sensor 3021 is a frequency sensor, which is capable of sensing the frequency signal when the lamp number controller 401 is operated, so as to generate a control signal. When being disposed within the direction lamp 402, the sensor 3021 is a light sensor, which is capable of sensing whether the direction lamp emits lights or not, so as to generate a control signal). During the usage, the sensing and emitting module 302 communicates with the receiver 3013 of the light fitting 301 through the emitter 3022 by means of wireless transmission, such that the control signal generated by the sensor 3021 is sent to the receiver 3013 of the light fitting 301 through the emitter 3022 of the sensing and emitting module 302, thereby actuating the light source 3012 to emit lights.

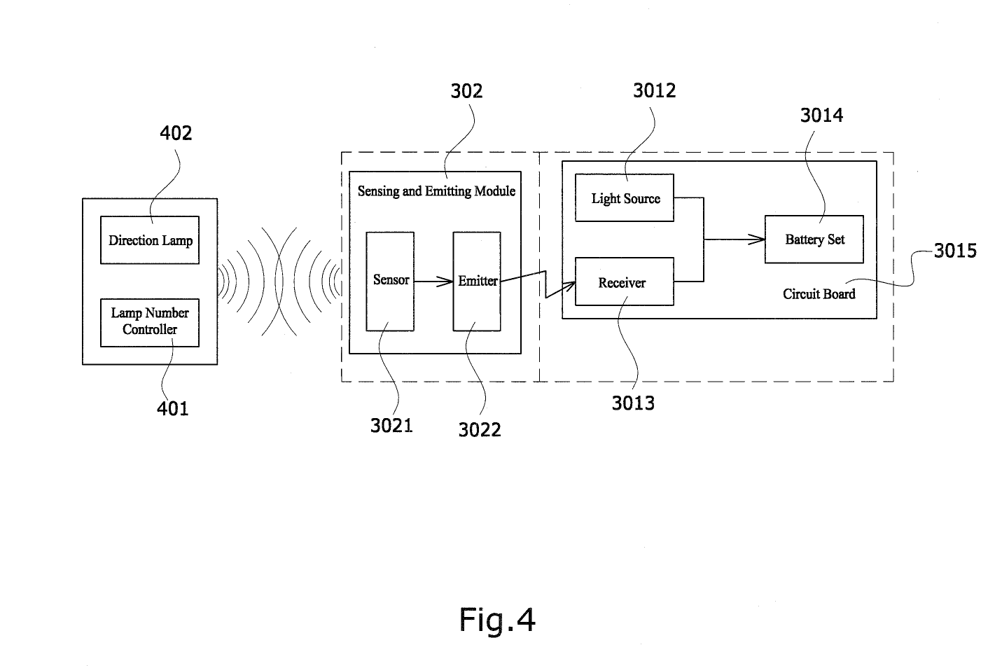

Referring to FIG. 4, it is a hardware block diagram of a preferred embodiment of the present invention. The light source 3012, the receiver 3013, and the battery set 3014 of the direction indicator lamp 30 are disposed on a circuit board 3015. The light source 3012 is electrically connected to the battery set 3014, the receiver 3013 is also electrically connected to the battery set 3014, and the light source 3012 and the receiver 3013 are communicated with each other. The sensing and emitting module 302 on the other end includes a sensor 3021 and an emitter 3022, which are powered by an internal battery set, or powered by electrically connecting to the original power source of the vehicle. During actuation, the sensor 3021 senses the signal frequency when the lamp number controller 401 is operated, or senses the lights when the direction lamp 402 emits lights, so as to generate a control signal. Then, the control signal is sent to the receiver 3013 of the light fitting 301 through the emitter 3022 by means of wireless transmission, and then the light source 3012 is actuated by the receiver 3013 to emit lights. Therefore, the direction indicator lamp of the present invention can be installed without additional wiring, such that it can be randomly placed at any position of the vehicle 40, which is quite suitable for the user to install manually.

As described above, the direction indicator lamp of the present invention has the following advantages.

1. The light fitting and the sensing and emitting module are independently designed in the present invention, the light fitting randomly located at any position of the vehicle can be actuated to emit lights through the sensing and the wireless transmission technique, so as to avoid using a great number of electrical connecting wires for wiring as the conventional direction lamp is installed, and thus avoiding the problems of damage and short circuit of the electrical connecting wires resulted from the friction.

2. Furthermore, the bottom surface of the light fitting is disposed with various adhesion portions with different features, so that the light fitting can be quickly mounted at any position on the surface of the vehicle, and thus it is convenient to dissemble the light fitting for maintenance and battery replacement.

3. In addition, a semi-permeable mirror is disposed on a surface of the case. When the light source does not emit lights, the light-tight mirror may be formed on the surface of the semi-permeable mirror, for reflecting the lights irradiated from the back of the vehicle, so as to achieve another indicating effect.

In view of the above, the above embodiments are merely preferred embodiments of the present invention, but not to restrict the scope of the present invention. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

To sum up, the direction indicator lamp of the present invention does conform to the creativeness requirements as a patent and also has industrial applicability. Therefore, the present invention is filed for an innovation patent according to the law.

What is claimed is:

1. A direction indicator lamp, comprising:
a light fitting, having a light source, a receiver, and a battery set disposed within a case thereof, wherein the light source and the receiver are electrically connected to the battery set; and
a sensing and emitting module, having a sensor and an emitter disposed therein, wherein the sensor and the emitter are communicated with each other; and during usage, the sensing and emitting module communicates with the receiver of the light fitting through the emitter by means of wireless transmission.

2. The direction indicator lamp as claimed in claim 1, wherein the case has a semi-permeable mirror disposed on a top surface thereof, and has an adhesion portion disposed on a bottom surface thereof.

3. The direction indicator lamp as claimed in claim 2, wherein the adhesion portion is an adhesion tape.

4. The direction indicator lamp as claimed in claim 2, wherein the adhesion portion is a sucking disk.

5. The direction indicator lamp as claimed in claim 2, wherein the adhesion portion is a magnet.

6. The direction indicator lamp as claimed in claim 1, wherein the case is L-shaped, and is formed by mutually assembling a transparent first case with a second case, and a waterproof ring is disposed at a position where the first case is assembled with the second case.

7. The direction indicator lamp as claimed in claim 1, wherein the light source, the receiver, and the battery set are disposed on a circuit board.

8. The direction indicator lamp as claimed in claim 1, wherein the sensor is a frequency sensor.

9. The direction indicator lamp as claimed in claim 1, wherein the sensor is a light sensor.
